(19) United States
(12) Patent Application Publication
(10) Pub. No.: US 2021/0223350 A1
(43) Pub. Date: Jul. 22, 2021

(54) GATEWAY DEVICE FOR A LOCATION BASED SENSOR NETWORK, AND ARRANGEMENT AND METHOD THEREOF

(71) Applicant: Sensire Oy, Joensuu (FI)

(72) Inventors: Ossi LAAKKONEN, Joensuu (FI); Aki HÄNNIKÄINEN, Joensuu (FI); Antti TOLONEN, Joensuu (FI)

(73) Assignee: Sensire Oy, Joensuu (FI)

(21) Appl. No.: 17/256,054

(22) PCT Filed: Jul. 1, 2019
(86) PCT No.: PCT/EP2019/067607

§ 371 Date: Dec. 24, 2020

Related U.S. Application Data
(60) Provisional application No. 62/691,763, filed on Jun. 29, 2018.

(51) Int. Cl. G01S 5/02; H04W 4/029; H04W 64/00

(52) U.S. Cl. CPC G01S 5/0231; G01S 2205/09; H04W 64/003; H04W 4/029

(57) ABSTRACT

A gateway device for controlling sensor network transmission frequency comprising: means to detect the gateway device location, transmission means arranged to at least transmit a beacon signal in the UHF band, characterized in that the gateway device is arranged to detect radio frequency band limitations associable with the detected location, and further sending beacon signal on 868/915 MHz frequency, or on 2.4 GHz frequency or other available ISM/SRD frequency if frequency band limitations associable with the gateway location are detected. Corresponding arrangement and method are also presented.

### FIELD OF THE INVENTION

Generally, the present invention relates to electronic devices and short-range sensor network arrangements. Particularly, however not exclusively, the invention pertains to an electronic device, arrangement and method for operating at different RF bands.

### BACKGROUND

Monitoring remotely cargo units is an essential part of modern tracking of intermodal transportation means. However, tracking sensors in use today comprise limited means to determine the location of the sensors as well as fixed means for communicating on certain frequency bands. Moreover, such systems may have limitations to be used only on certain locations and/or jurisdictions because of potential network usage limitations in other locations.

Utilizing optimal network means for transmitting data during international transit is an important aspect for intelligent cargo tracking. This is important for network data rate efficiency, energy efficiency as well as being usable in a wide range of different jurisdictions with different rules and limitation for network frequency band usage.

Being able to monitor cargo whatever the transportation means is and in sufficiently real-time is essential for managing the whole supply chain in an intelligent and preemptive manner.

Prior art solutions have approached the tracking sensor management either by not having any positioning means or by having positioning means in the tracking sensor which makes the tracking sensor itself more complicated in design and more expensive as well. In system with a vast amount of sensors it is of essence to reduce the complexity and cost of single tracking sensors. Moreover, commonly sensors have a single predetermined frequency range for short-range or long-range communications.

### SUMMARY OF THE INVENTION

The objective of the embodiments of the present invention is to at least alleviate one or more of the aforementioned drawbacks evident in the prior art arrangements particularly in the context of sensor networks with fixed communications frequencies. The objective is generally achieved with a gateway device, sensor network arrangement and method thereof in accordance with the present invention.

The present solution offers an intelligent arrangement for a sensor network to operate at different preferred frequencies in different zones facilitated by control at a gateway device.

In accordance with one aspect of the present invention a gateway device for controlling sensor network transmission frequency comprising:
means to detect the gateway device location,
transmission means arranged to at least transmit a beacon signal in the UHF band,
   characterized in that the gateway device is arranged to detect radio frequency band limitations associable with the detected location, and further sending beacon signal on 868/915 MHz frequency, or on 2.4 GHz frequency or other available ISM/SRD frequency if frequency band limitations associable with the gateway location are detected.

According to an exemplary embodiment of the present invention the gateway device comprise Cell-ID, triangulation or satellite navigation means to detect the gateway device location.

According to an exemplary embodiment of the present invention the gateway device comprises a memory for storing and retrieving radio frequency band limitations associable with the different locations.

According to an exemplary embodiment of the present invention the gateway device is arranged to retrieve radio frequency band limitations associable with the detected location from an Internet database or an external server.

In accordance with one aspect of the present invention an arrangement for controlling sensor network transmission frequency comprising:
a gateway device comprising means to detect the gateway device location,
at least one sensor comprising communication means in the UHF band arranged to at least receive the beacon signal from the gateway device,
   characterized in that the gateway device is arranged to detect radio frequency band limitations associable with the detected location, and further sending beacon signal on 868/915 MHz frequency, or 2.4 GHz frequency or other available ISM/SRD frequency if frequency band limitations associable with the gateway location are detected, wherein the sensor communications are idle if no beacon signal is detected.

In accordance with one aspect of the present invention a method for controlling sensor network transmission frequency comprising:
detecting gateway location,
determining RF frequency limitations associable with the location,
transmitting beacon signal on a preferred RF frequency,
receiving beacon signal at a node,
setting node transmission frequency to the beacon signal RF frequency.

As briefly reviewed hereinbefore, the utility of the different aspects of the present invention arises from a plurality of issues depending on each particular embodiment.

The expression “a number of” may herein refer to any positive integer starting from one (1). The expression “a plurality of” may refer to any positive integer starting from two (2), respectively.

The term “exemplary” refers herein to an example or example-like feature, not the sole or only preferable option.

Different embodiments of the present invention are also disclosed in the attached dependent claims.

### BRIEF DESCRIPTION OF THE RELATED DRAWINGS

Next, some exemplary embodiments of the present invention are reviewed more closely with reference to the attached drawings, wherein

FIG. 1 illustrates a flow chart of a method in accordance with an embodiment of the present invention.

FIG. 2 illustrates an arrangement and some associated aspects thereof in accordance with an embodiment of the present invention.

FIG. 3 illustrates a block diagram of the gateway device in accordance with an embodiment of the present invention.

FIG. 4 illustrates a block diagram of a tracking sensor node in accordance with an embodiment of the present invention.

### DETAILED DESCRIPTION OF THE EMBODIMENTS

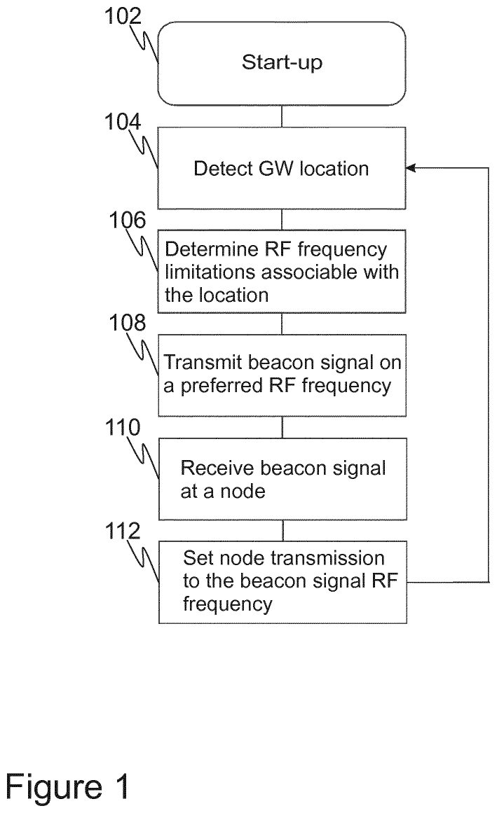

FIG. 1 illustrates a flow chart of a method in accordance with an embodiment of the present invention.

At 102, the sensor network may be initialized by e.g. connecting the gateway on 868/915 MHz or similar ISM (industrial, scientific and medical) frequency band with nodes, such as tracking sensor nodes for tracking cargo units.

At 104, the gateway device detects the location of the gateway device.

At 106, the gateway device determines RF frequency limitations associable with the detected location, such as frequency bands for which use is prohibited or requires particular permits to use. The RF frequency limitations may comprise information on allowable RF frequency bands or simply determining whether the preferred 868/915 MHz frequency band or other ISM/SRD (short-range device) band is allowable or not allowable at that location. The gateway device transmission band is set to 868/915 MHz unless there is a limitation of not using it in which case the gateway device switches the transmission to 2.4 GHz frequency band, which is usable worldwide. In some embodiments also other such frequency band usable worldwide for short-range communications may be used.

At 108, beacon signals are sent on the frequency band determined to be used by the gateway device.

At 110, the nodes receive beacon signals at a frequency band. In case beacon signal is not received at a node the node stays idle but keeps on listening to the UHF frequencies for beacon signals. The idle state may comprise keeping receiving means on while disabling other functions, such as transmission, or the idle state may comprise an idle state wherein the whole node is idle for a period of time and is arranged to turn on the receiver for listening to beacon signals.

At 112, the nodes set their transmission to the frequency band on the frequency band which the beacon signal was received.

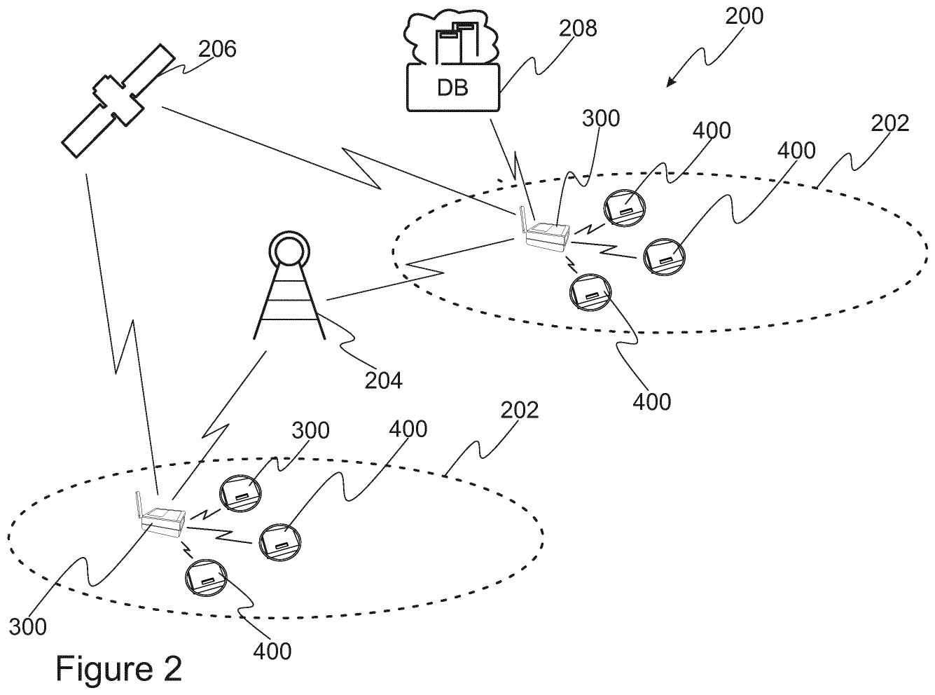

FIG. 2 illustrates an arrangement (200) and some associated aspects thereof in accordance with an embodiment of the present invention.

The arrangement (200) comprises a number of gateway devices (300) and nodes (400) as clusters forming a number of short-range communications sensor networks (202). A gateway device (300) determines its location e.g. via Cell ID, triangulation or satellite based positioning means, by connection with a number of base stations (204) and/or satellite systems (206). The use of positioning means may be determined by the availability of said positioning means or coverage. In view of the determined location the gateway device (300) is arranged to detect radio frequency band limitations associable with the detected location. The gateway device (300) may be arranged to detect or determine the allowable RF frequencies or limitations with the RF frequencies associable with the location via communication with an external database (208), such as a database on a cloud server, wherein the information of allowable RF frequencies or limitation with the RF frequencies associable with the location may be stored, or by retrieving such information from the internal memory of the gateway device (300).

The gateway device (300) continuously transmits beacon signals on a frequency allowed in the determined location. Preferably, the primary RF frequency for communicating with the sensor network nodes (400) is 868/915 MHz. If the 868/915 MHz band is allowable in the determined location of the gateway device (300) the gateway device (300) sends beacon signals on said frequency band to the nodes (400) in its coverage. The nodes (400) in the sensor network (202) are arranged to change their transmission frequency to the detected gateway device (300) beacon signal frequency and so the nodes (400) utilize the same RF frequency band for data transmission as determined suitable by the gateway device (300).

Secondarily, the gateway device (300) may detect that in a determined location the RF frequency band 868/915 MHz is not allowable in which case the transmission of beacon signals is changed to 2.4 GHz frequency or to another available ISM/SRD frequency. Correspondingly, when receiving the beacon signals on the different frequency the nodes (400) change their transmission frequency to the beacon signal frequency. The sensors may set to an idle mode if no beacon signal is detected in predetermined time frame. The idle state may be arranged with a sleep/wake up scheme such that the node (400) is waken up at a predetermined frequency for receiving beacon signals. Optionally, the gateway device (300) may be arranged to follow a certain scheme with the nodes (400) so that the nodes (400) know the frequency at which beacon signals should be receivable and during which times the nodes (400) may stay idle for energy conservation.

In the arrangement (200) preferably only the transmission frequency bands of the nodes (400) are changed in view of gateway device (300) determined RF frequency limitations as the nodes (400) are arranged to continuously receive on a wide array of UHF frequencies in case the beacon signal frequency changes.

Some exemplary applications of the arrangement (200) comprise intermodal containers and shipping containers in general, cargo spaces, trailers, and any such spaces that move between countries and continents with different utilizable RF bands.

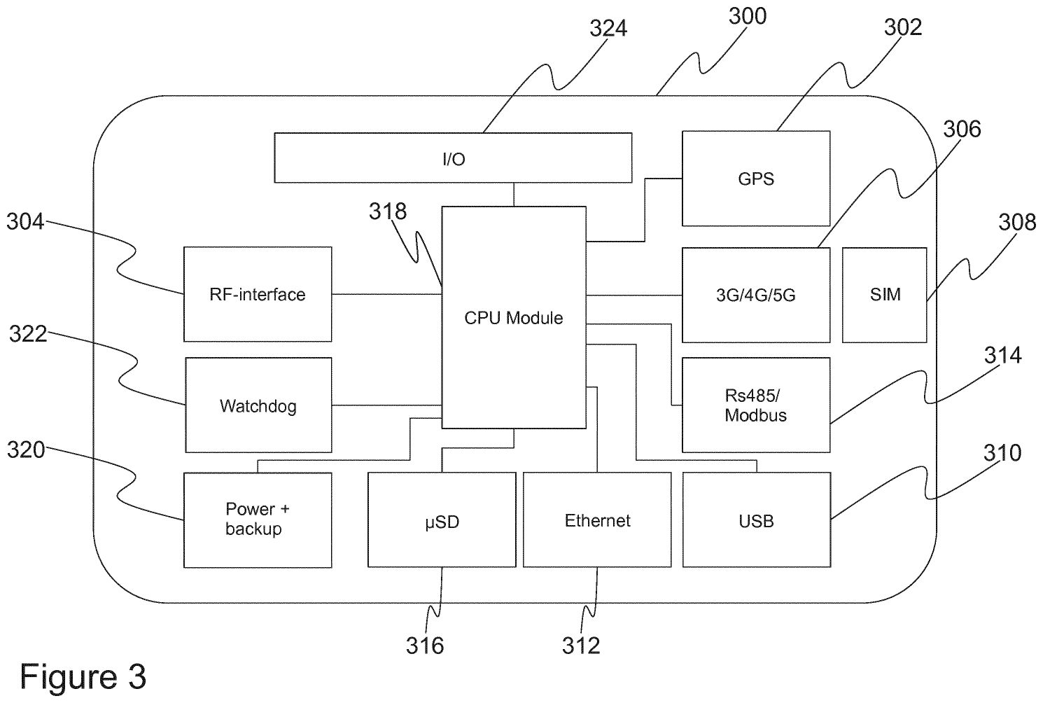

FIG. 3 illustrates a block diagram of the gateway device (300) in accordance with an embodiment of the present invention.

The gateway device (300) comprises means to detect the gateway device (300) location. For this purpose, some feasible positioning systems comprise e.g. GPS, A-GPS, GLONASS, GNSS, IRNSS, SBAS and BeiDou satellite systems. For positioning means, the gateway device (300) may comprise a chip, antenna or other such positioning components, such as a GPS chip (302). Another feasible means to detect the gateway device (300) location or gateway device movement (change of location) comprises Cell-ID or triangulation via connection with a number of base stations (204).

The gateway device (300) further comprises an RF-interface (304) with at least wireless UHF short-range transmission means and preferably also receiving means, such as IEEE 802.11, IEEE 802.15.1 and/or such ISM/SRD band communication means for at least connecting with wireless nodes and optionally also for receiving tracking data from the tracking sensor nodes (400).

The gateway device (300) may also comprise long-range communication means (306) to form an uplink via NB-IoT, LTE Cat-M1 and 2G/3G/4G/5G communication techniques. When needed, the gateway device (300) may also comprise a card SIM or a chip/software based E-SIM (308) for long-range communications via cellular means.

The gateway device (300) may be connected to a cargo unit, such as a truck, train or boat positioning or communications system, via a USB (310), Ethernet (312), Modbus or RS485 (314) or other cargo unit communication bus to receive information of movement or change in location.

The gateway device (300) may comprise also other essential components or circuits such as a memory (316) for storing information about RF frequency limitations associable with different locations and for storing tracking sensor data collected from tracking sensor nodes in the sensor network. The memory (316) may be used for retrieving information about RF frequency limitations associable with certain locations, which may be used when said information cannot be, or is not preferred to be, retrieved from a remote server (208) or such e.g. due to lack of cellular or WAN network coverage. This way RF frequency limitations may be determined without accessing a database or the Internet containing the information and by only determining the gateway device (300) location. The memory (316) may be accessed and controlled by a CPU module (318), which may also carry various other tasks of the gateway device (300), such as controlling the transmission and receiving of data as well as positioning of the gateway device (300). The CPU module (318) may also be part of a RF SoC (System on a Chip). The CPU module (318) may comprise a FPU (Floating Point Unit), Flash memory and RAM (Random Access Memory). The gateway device (300) may further comprise a battery and power management means (320). The gateway device (300) may also comprise a watchdog timer (322) connected to the CPU module (318) for error detection. The gateway device (300) may also comprise a number of I/O ports (324) for connecting the gateway device (300) with peripheral devices.

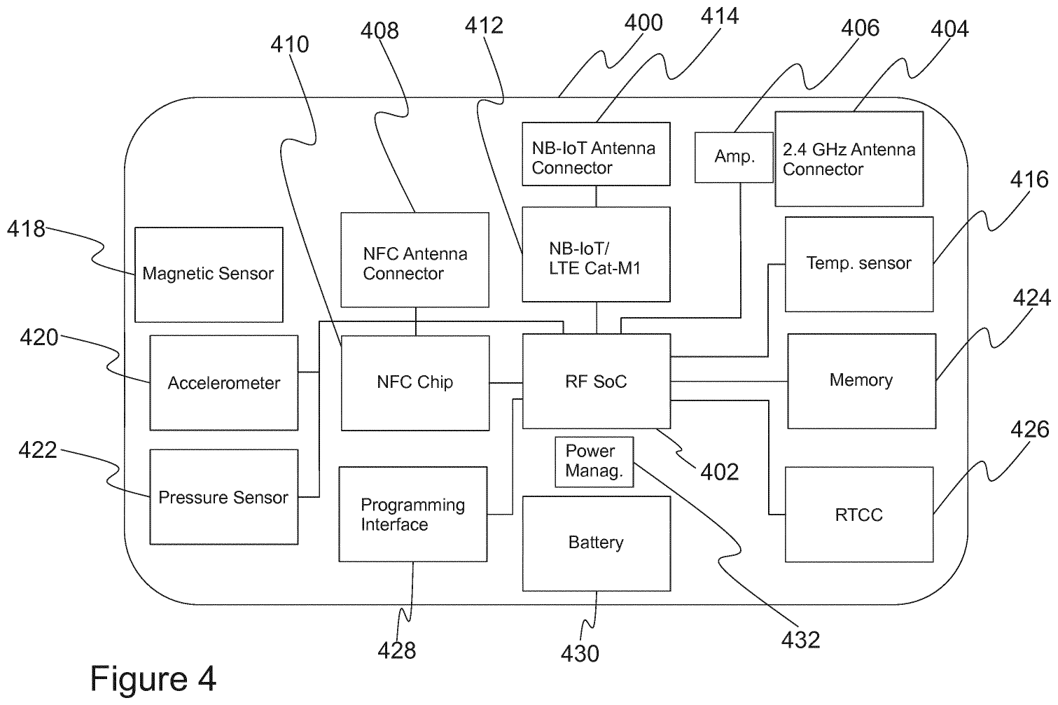

FIG. 4 illustrates a block diagram of a tracking sensor node (400) in accordance with an embodiment of the present invention.

The tracking sensor node (400) comprises at least an UHF transmitter, receiver and/or transceiver arranged to at least receive beacon signals from the gateway device (300) and to transmit signals to the gateway device (300) via short-range communications means. The UHF transmitter, receiver and/or transceiver may comprise one or more circuits and components pertaining to RFID, NFC, IEEE 802.11 a/b/g/n, IEEE 802.15.1, IEEE 802.15.4 and/or such ISM/RSD band communication techniques and may be provided with a RF SoC (402). For example, the RF SoC (402) may be connected to a 2.4 GHz antenna connector (404) with an amplifier (406) for facilitating a transceiver for short-range communications. The RF SoC (402) may be also connected to an NFC chip (408) and NFC antenna connector (410) for facilitating a transceiver for near-field communications. The UHF tracking node sensor (400) receiver and/or transceiver is preferably essentially constantly on so that the presence of a gateway device (300) is detected via the beacon signals received from the gateway device (300) and hence that the tracking node sensor (400) may connect with the gateway device (300) in the short-range sensor network zone.

The tracking sensor nodes (400) may comprise also long-range transmission means for transmitting data to a base station. The long-range transmission means may comprise one or more circuits, chips (412), antenna connectors (414), antennas and amplification means pertaining NB-IoT, LTE Cat-M1 and 2G/3G/4G/5G communication techniques.

The tracking sensor nodes (400) preferably comprise active tracking sensors, which include active sensing means of a number of preferred parameters for detecting the parameter with a sensor, and transmitting at least the sensor tracking data, such as measurement data, alerts, and/or metadata pertaining to measurements or the node functioning, to the gateway device (300) and/or to a base station wherefrom it may be delivered to a cloud database.

The tracking sensor nodes (400) may comprise one or more sensing means such as a number of ambient temperature sensors (416), magnetic sensors (418), accelerometers (420), pressure sensors (422) and gyroscope. These sensors may be used to detect ambient pressure, temperature, changes in velocity and rotation of the cargo, which may be further used to determine and monitor the conditions of the cargo that is transported. Clearly, other such sensing means for detecting events or changes in the ambient or internal conditions of the tracking sensor node (400) may be also utilized.

The tracking sensor nodes (400) may comprise also other essential components or circuits such as a memory (424) for at least for collecting tracking sensor data, such as sensing means measurements. The memory (424) may be used to store the sensor data also for longer periods of time when data transmission from the node (400) is disabled or otherwise limited.

The tracking sensor node (400) may also comprise a real-time clock (RTC) or a real-time clock and calendar (RTCC) circuit (426) e.g. for executing a sleep/wake up scheme. The node (400) may also comprise a programming interface (428) connected to the RF SoC (402) as well as typical battery and power management means (430, 432).

The scope of the invention is determined by the attached claims together with the equivalents thereof. The skilled persons will again appreciate the fact that the disclosed embodiments were constructed for illustrative purposes only, and the innovative fulcrum reviewed herein will cover further embodiments, embodiment combinations, variations and equivalents that better suit each particular use case of the invention.

1. A gateway device for controlling sensor network transmission frequency comprising:
means to detect the gateway device location,
transmission means arranged to at least transmit a beacon signal in the UHF band, wherein the gateway device is arranged to detect radio frequency band limitations associable with the detected location, and further sending beacon signal on 868/915 MHz frequency, or on 2.4 GHz frequency or other available ISM/SRD frequency if frequency band limitations associable with the gateway location are detected.

2. The gateway device of claim 1 wherein the gateway device comprises Cell-ID, triangulation or satellite navigation means to detect gateway device location.

3. The gateway device of claim 1 wherein the gateway device comprises a memory for storing and retrieving radio frequency band limitations associable with the different locations.

4. The gateway device of claim 1 wherein the gateway device is arranged to retrieve radio frequency band limitations associable with the detected location from an Internet database or an external server.

5. An arrangement for controlling sensor network transmission frequency comprising:
a gateway device comprising means to detect the gateway device location,
at least one sensor comprising communication means in the UHF band arranged to at least receive the beacon signal from the gateway device, wherein the gateway device is arranged to detect radio frequency band limitations associable with the detected location, and further sending beacon signal on 868/915 MHz frequency, or 2.4 GHz frequency or other available ISM/SRD frequency if frequency band limitations associable with the gateway location are detected, wherein the sensor communications are idle if no beacon signal is detected.

6. A method for controlling sensor network transmission frequency comprising:
detecting gateway location,
determining RF frequency limitations associable with the location,
transmitting beacon signal on a preferred RF frequency,
receiving beacon signal at a node, and
setting node transmission frequency to the beacon signal RF frequency.
